(19) United States
(12) Patent Application Publication
(10) Pub. No.: US 2008/0191177 A1
(43) Pub. Date: Aug. 14, 2008

(54) Polymeric Strain Sensor

(75) Inventors: David Mainwaring, Victoria (AU); Pandiyan Murugaraj, Victoria (AU); Nelson Eduardo Mora Huertas, Victoria (AU)

Correspondence Address: CONNOLLY BOVE LODGE & HUTZ LLP, 1875 EYE STREET, N.W., SUITE 1100, WASHINGTON, DC, 20036, US

(73) Assignee: Royal Melbourne Institute of Technology, Melbourne, Victoria (AU)

(21) Appl. No.: 11/914,732

(22) PCT Filed: May 24, 2006
(86) PCT No.: PCT/AU06/00680

§ 371 Date: Nov. 16, 2007

(30) Foreign Application Priority Data
May 25, 2005 (AU) 2005902662
Sep. 13, 2005 (AU) 2005905029

(51) Int. Cl. H01B 1/20

(52) U.S. Cl. 252/511; 252/500

(57) ABSTRACT

A strain sensor consisting of a non conducting polymer incorporating conductive nanoparticles below the percolation threshold and preferably less than 10% v/v of the polymer. The polymer is a polyimide and the conducting nanoparticle is carbon black having an average particle size of 30-40 nm and an aggregate size of 100-200 nm. The sensor can sense strain in extension, compression and torsion.

### BACKGROUND TO THE INVENTION

Polymeric strain gauges have been proposed.

U.S. Pat. No. 5,989,700 discloses the preparation of pressure sensitive ink that can be used for the fabrication of pressure transducers such as strain gauges where the electrical resistance is indicative of the applied pressure. The ink has a composition of an elastic polymer and semiconductive nanoparticles uniformly dispersed in this polymer binder.

U.S. Pat. No. 5,817,944 discloses a strain sensor for a concrete structure containing conductive fibres.

U.S. Pat. No. 6,079,277 discloses a strain or stress sensor composed of a polymeric composite with a matrix of carbon filaments.

U.S. Pat. No. 6,276,214 discloses a strain sensor using a conductive particle—polymer complex. Carbon black is dispersed in an ethylene vinylacetate copolymer to produce a conductive polymeric matrix.

All these polymeric sensors are fabricated by preparing the conductive particles and then incorporating them in a polymer by solution or melt processing followed by film fabrication. This component is then pasted onto an insulating support and embedded onto the mechanical structure to be monitored. Electrical leads need to be connected to the sensor. Polymeric strain gauges relying on changes in resistance of a conducting film are usually unsatisfactory and do not have a long service life due to hysteresis. Generally metallic strain gauges are preferred. It is an object of this invention to develop a polymeric strain sensor that exhibits improved performance characteristics and low hysteresis.

### BRIEF DESCRIPTION OF THE INVENTION

To this end the present invention provides a composite polymeric strain sensor consisting of a non conducting polymer incorporating conductive nanoparticles below the percolating threshold and preferably less than 10% by volume of the polymer.

The relative low loading of the conducting particles compared to prior art polymeric strain sensors (typically 30% v/v) means that the composites are semiconducting compared to the prior art sensors which exhibit are metallic like.

The polymer is typically a polyimide material and the conducting particle is carbon of different forms including graphitic, carbon black and glassy carbon having an average particle size of 30-70 nm and an aggregate size of 100-200 nm. Such a nanocomposite strain sensor element along with conducting tracks can directly be printed or adhered on substrates under test by various casting, printing or conventional adhesion techniques to enable the element to be connected to an external electric circuit.

The relative low loading of the conducting particles compared to prior art polymeric strain sensors (typically 30% v/v) means that the composites are semiconducting compared to the prior art sensors which exhibit metallic like characteristics. The proposed composition is well below the percolation threshold compared to prior art composite sensors that rely on physical contacts between the conductive particles providing percolating network and are subjected to micromechanical hysteretic dislodgement. The prior art polymeric sensors measure decrease in conductivity due to breaking of percolative conduction paths in the composite. The low loading minimizes the degradation of the micromechanical characteristics of the polymer composites arising from a high volume loading.

These composites show enhanced electrical conductivity through an electron hopping mechanism. The electrical conductivity characteristics (temperature dependent/deformation dependent/voltage dependent etc.) of such a system depends on, the carbon particle size, concentration of carbon nanoparticles, and the inter-particle distances. The electrical conductivity of the composite structure progressively varies from 10⁻⁷ to 10⁻² S/cm when the carbon nanoparticle concentration is increased from 1% v/v to 8% v/v. As such, these composite films are semiconducting in their temperature behaviour, which is not exploited as such in the strain sensing but is characteristic of their behaviour as a non-percolating electron transfer mechanism exploited as a very low hysteretic strain sensor film. In these films, deformation dependent changes in electrical properties of the carbon-polyimide nanocomposite film (which crucially depends on the changes in the inter-particle gaps occurring during deformation process) is exploited to achieve a strain sensor as an application of these films.

The electrical conductivity in these carbon polymer nanocomposite thin films are critically dependent on the hopping of electrons between the nanoparticles embedded in the polymer matrix separated by well defined interparticle spacings unlike the prior art polymer strain sensor films that relay on the presence of the percolation network of the conducting particles for their electrical conductivity under zero strain. The semiconducting behaviour of these nanocomposite films under zero strain also provides a compensation mechanism for the temperature dependence of their resistance.

This enables the strain sensor element (SSE) of present invention to respond:
(a) to tensile (i.e. extensional) deformation, through a increase in the electrical resistance of the films due to widening of the inter-particle spacing under tensile strain as well as
(b) to compressive deformation, through a decrease in the electrical resistance of the SSE films arising from decreased inter-particle spacing under compressive loading, unlike the prior art polymer based strain sensors which will be insensitive to compressive loadings due to the presence of percolating network and
(c) to torsional deformation, by virtue of their response to both extensional and compressive deformations

This SSE can easily be manufactured and used in any shape or size including, thin or thick film or any solid shapes depending on the specific application and sensitivity requirements.

Such a unique capabilities of these SSEs enables quantitative monitoring, for example, of tensile and compressive deformations and forces, torsional deformations and forces, vibrations, impacts and sinusoidal deformations. A suitable class of polymers is polyimide which is commonly used in micro electronics devices. Polyimides have excellent micromechanical, chemical and electrical properties within a wide temperature range of −270 to 260° C.

A preferred conducting nanoparticle is carbon black having an average particle size of 30-70 nm and an aggregate size of 100-200 nm. A more preferred carbon content is about 1% v/v.

### DETAILED DESCRIPTION OF THE INVENTION

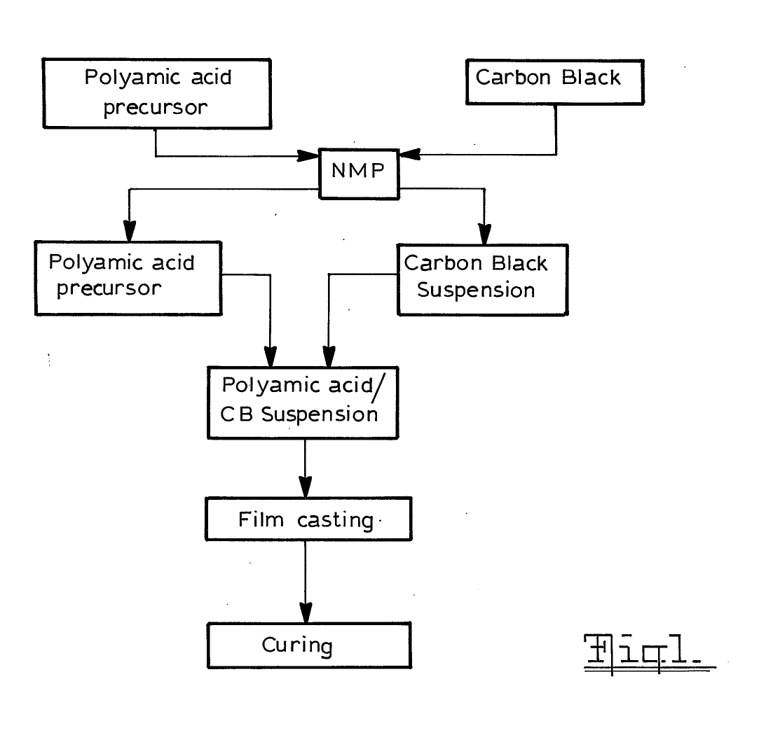

FIG. 1 illustrates the fabrication steps used in one embodiment of this invention;

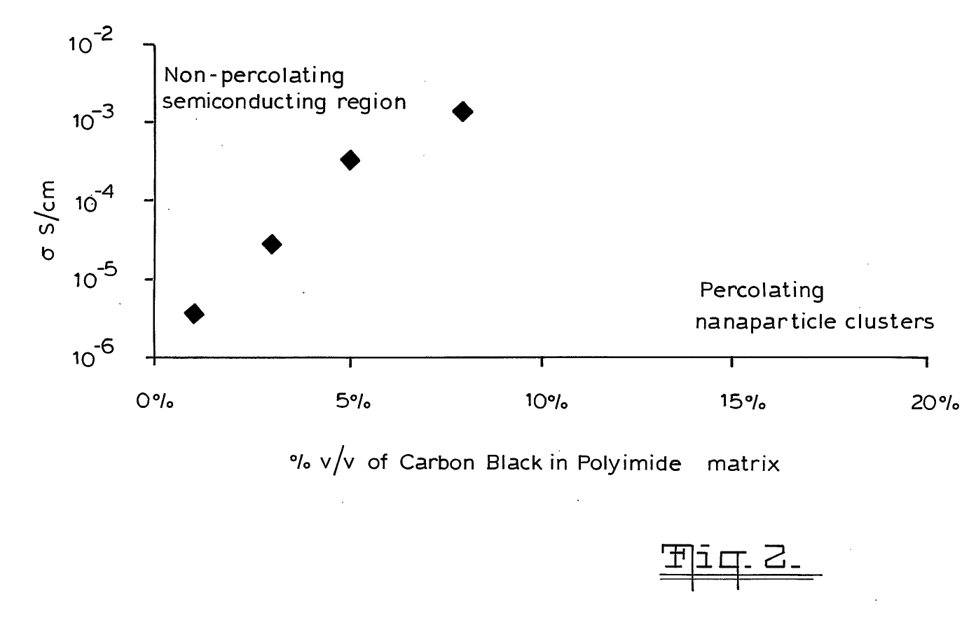

FIG. 2 illustrates the variation of electrical conductivity with carbon content at 20° C.;

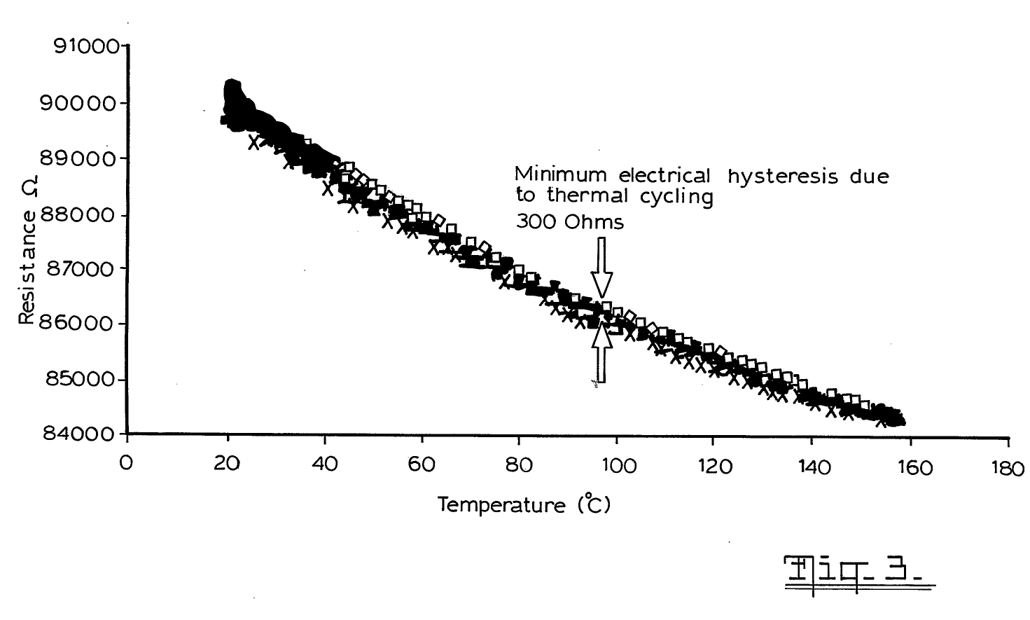

FIG. 3 illustrates Temperature Dependent electrical resistance variation between a free standing and a supported film;

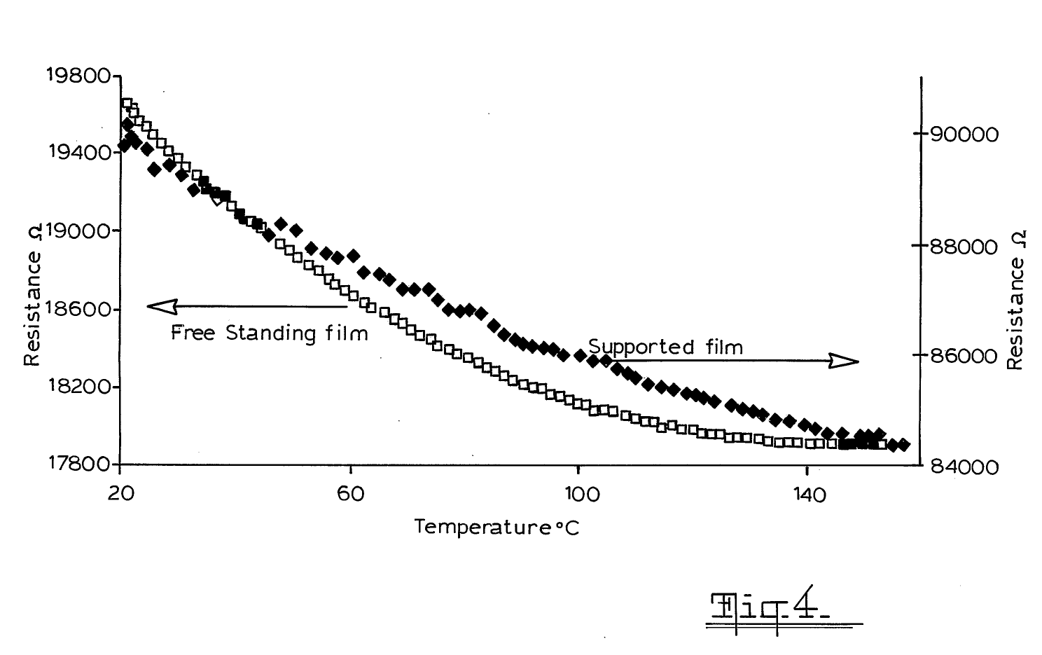

FIG. 4 illustrates the electrical hysteresis due to thermal cycling;

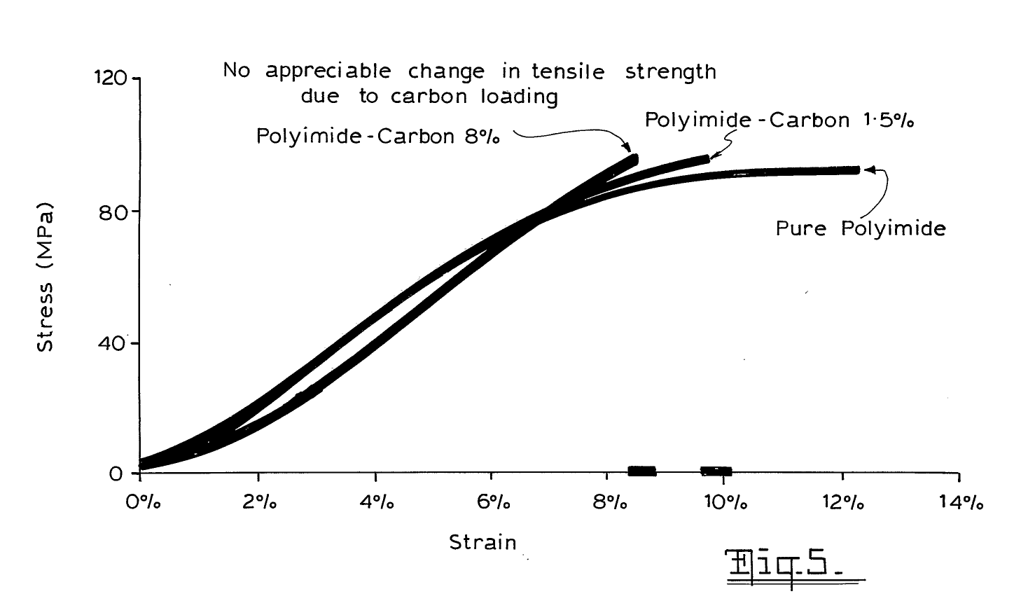

FIG. 5 illustrates typical micromechanical behaviour of the sensor of this invention compared to the unfilled polymer;

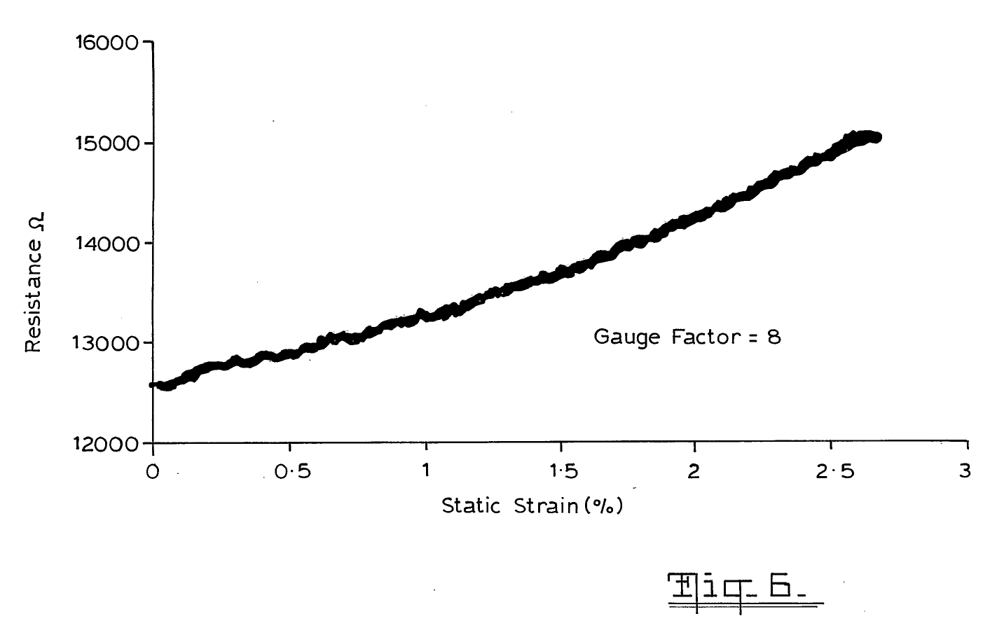

FIG. 6 illustrates typical electromechanical behaviour of the sensor of this invention;

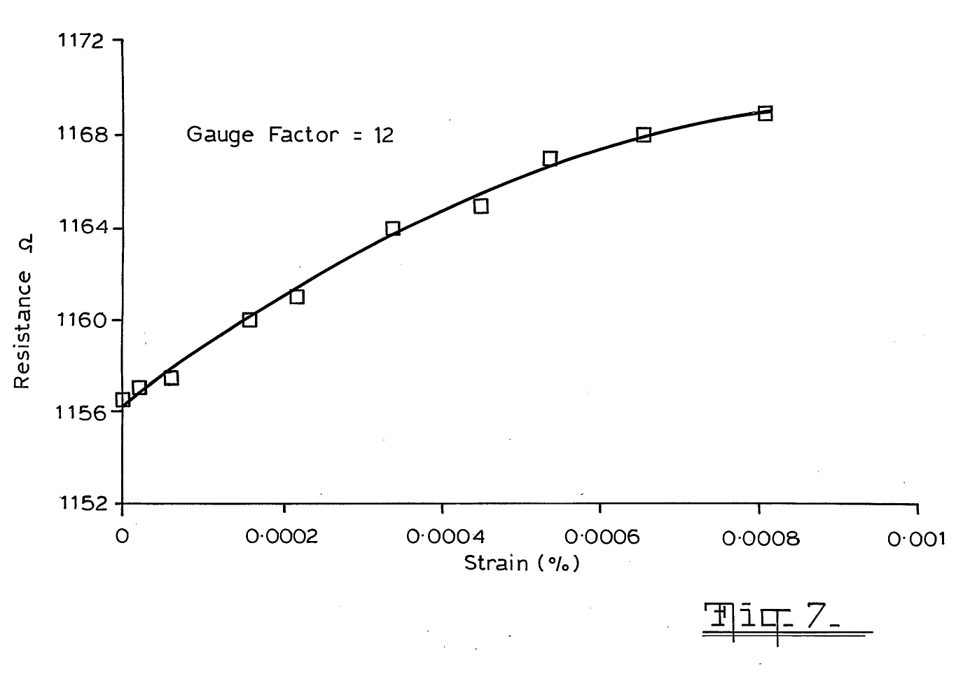

FIG. 7 illustrates the strain resistance change and the gauge factor of the sensors of this invention;

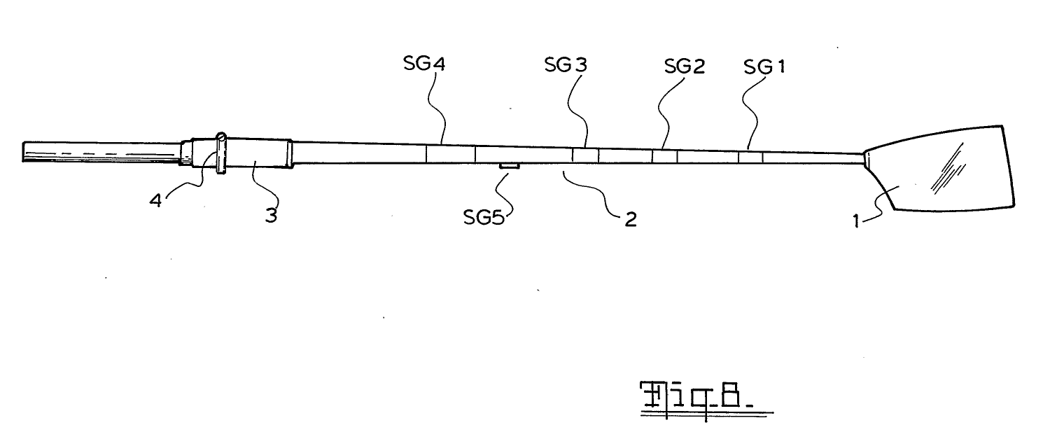

FIG. 8 is a schematic representation of the carbon fibre composite rowing Oar showing the locations of the SSEs that were placed along the axis of the Oar;

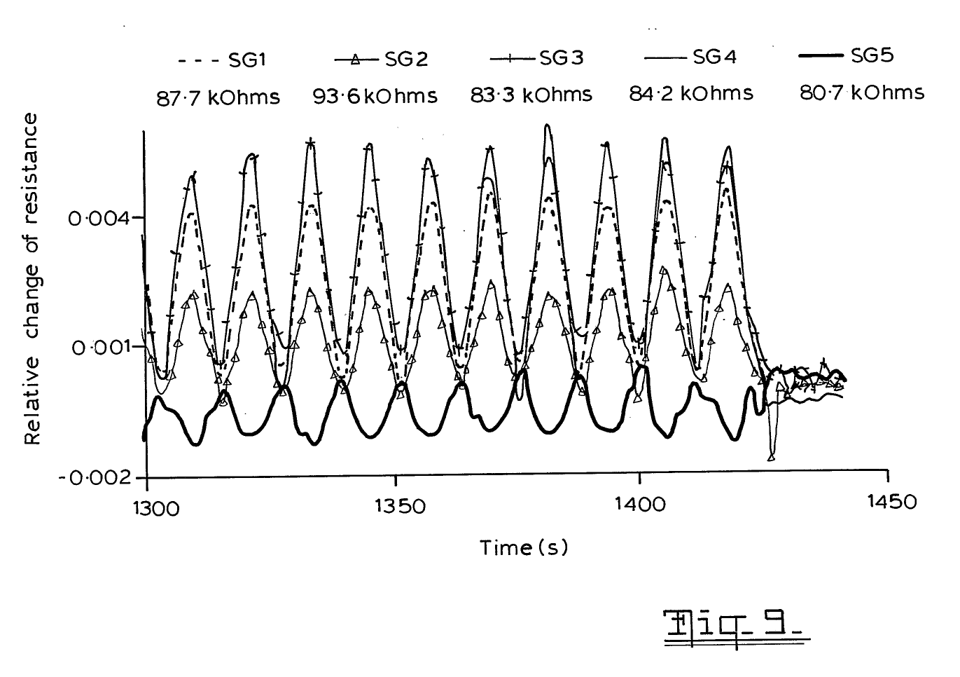

FIG. 9 is a graph of resistance ratio plotted against time obtained for the strain sensor elements during cyclic deformation of the Oar;

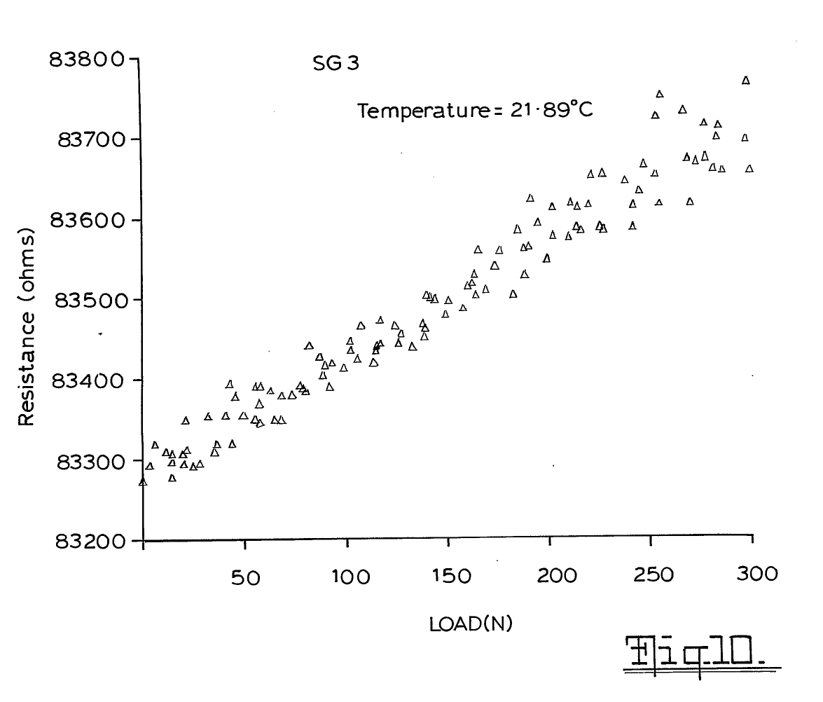

FIG. 10 is a plot of the change in resistance with applied load obtained for a strain sensor element;

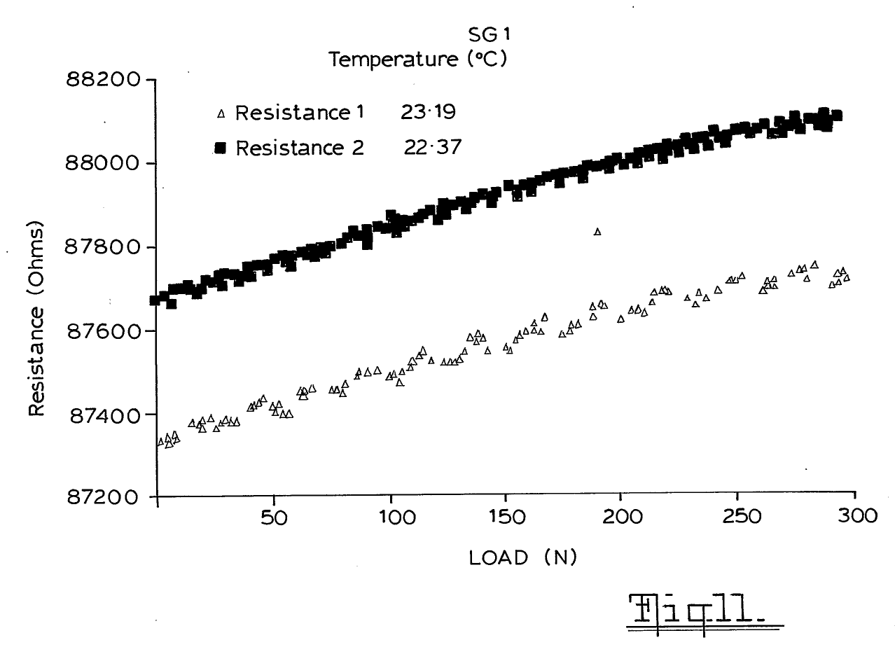

FIG. 11 is a graph of resistance variation experienced by a strain sensor element, SG1 obtained during cyclic loading experiments at two different temperatures;

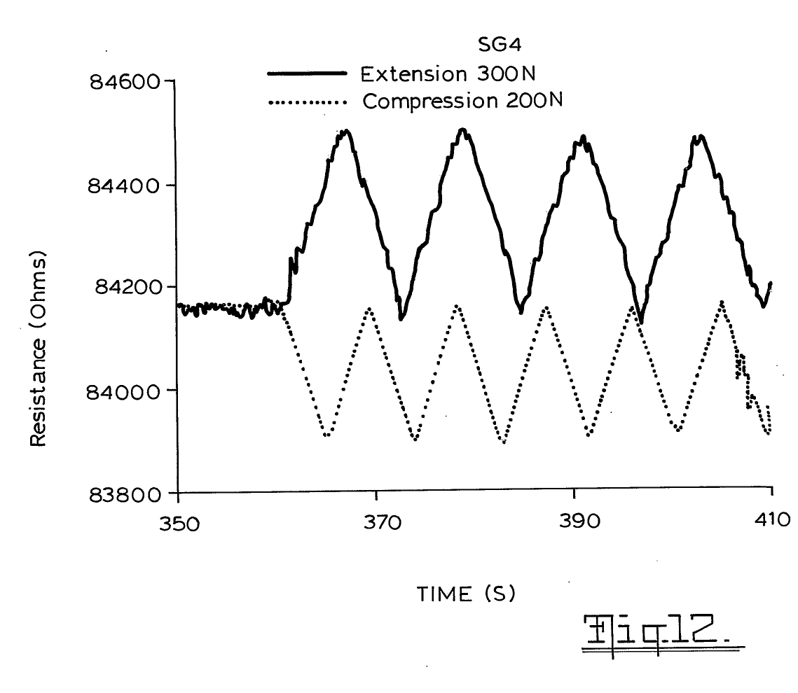

FIG. 12 is resistance variation plotted against time during cyclic loading on a given strain sensor element;

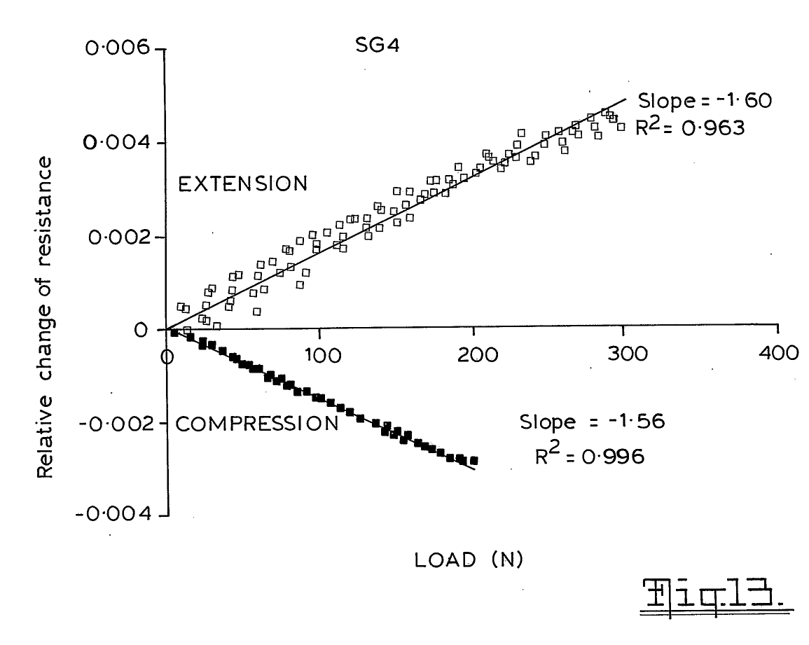

FIG. 13 is graph of relative change in resistance of a SSE when it is subjected to extensional and compressive deformation;

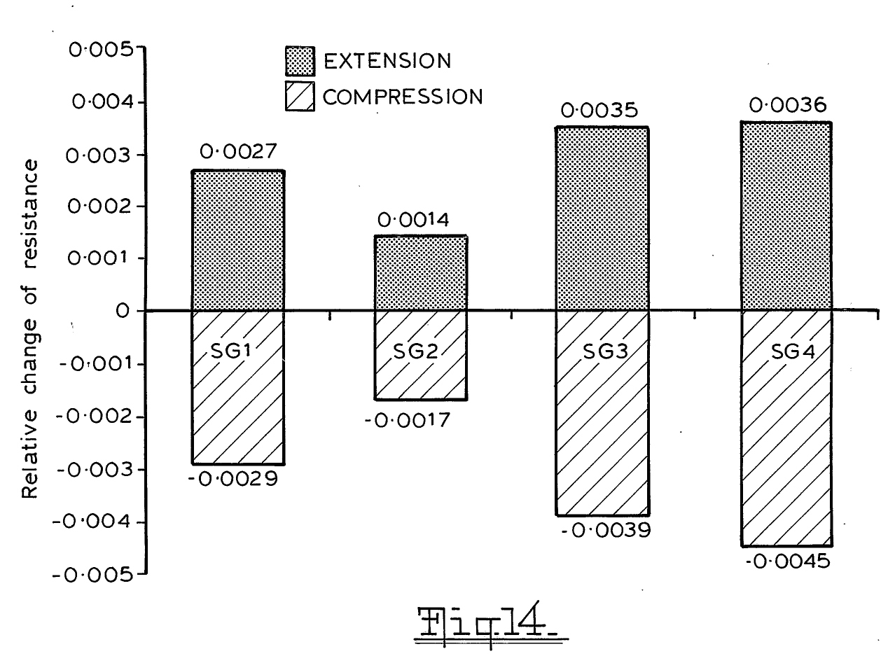

FIG. 14 is a graph relative change in resistance obtained for all the strains sensor elements placed along the axis of the Oar shaft for an extensional as well as for a compressive deformation produced by application of 200 N;

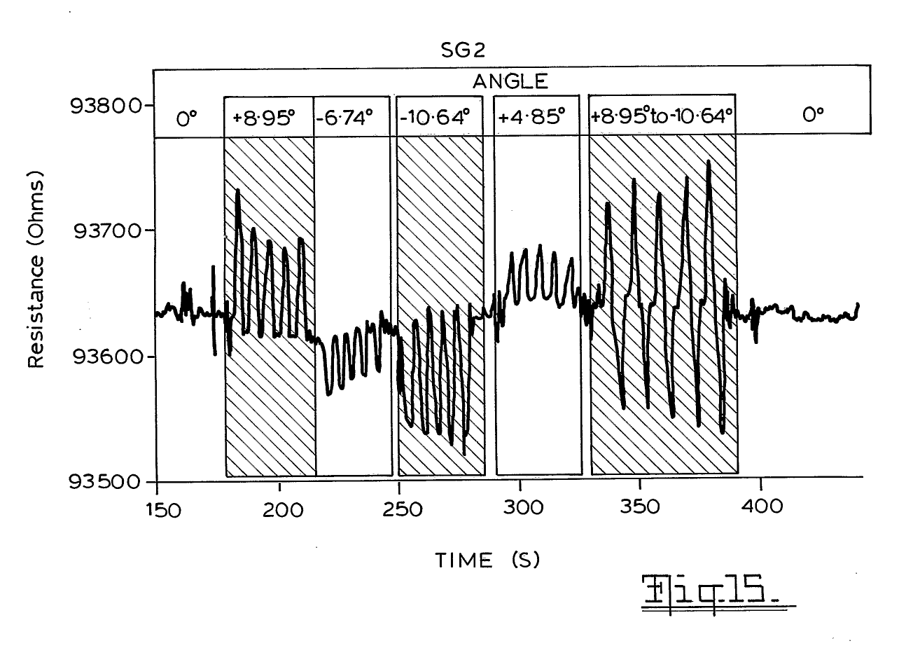

FIG. 15 is a graph of resistance change plotted against time when cyclic torsional deformation was applied to the Oar shaft in the clockwise and anti-clockwise directions;

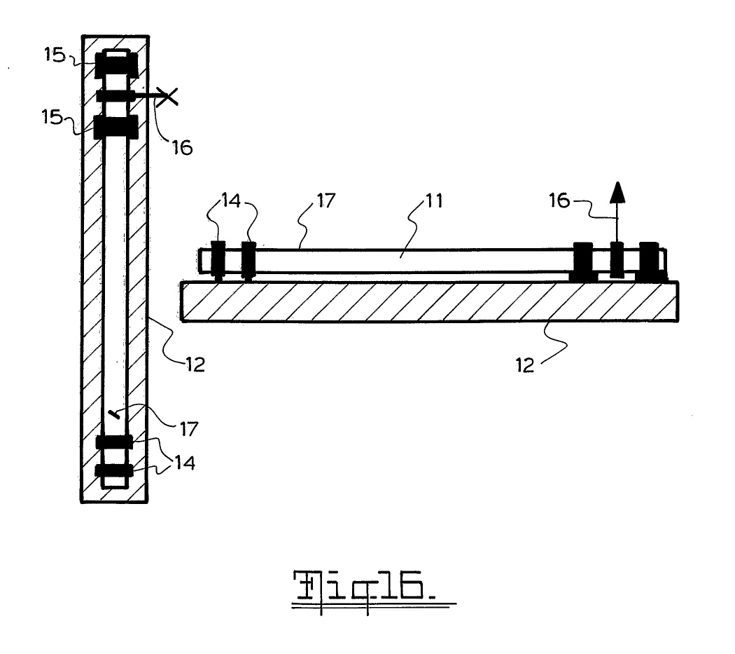

FIG. 16 is a schematic diagram providing details of the carbon fibre composite tube positioning for torsional deformation measurement using an instron machine;

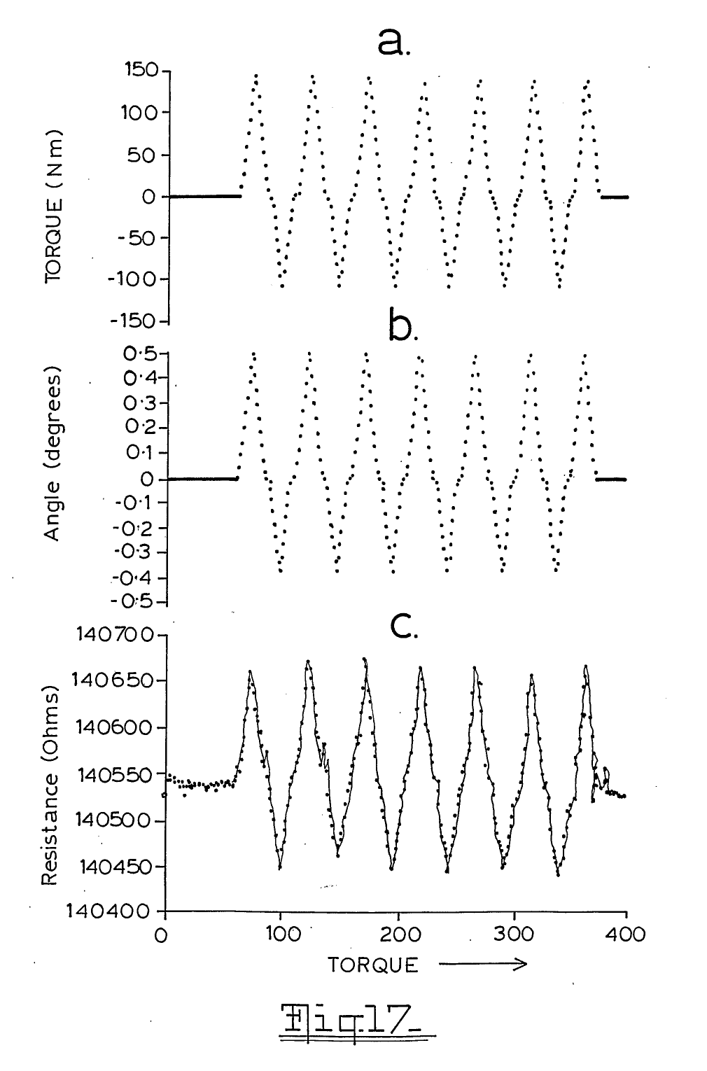

FIG. 17 shows the variation of a) Torque applied on the tube, b) torsional deformation in Angle (degrees) and c) Electrical Resistance of SSE with time when cyclic torsional deformation was applied to a carbon fibre composite tube.

As shown in FIG. 1 the nanocomposite film is fabricated by incorporating the Carbon black into the precursor of the polyimide, i.e., polyamic acid of benzophenone tetracarboxylic dianhydride and 4,4′-oxybisbenzenamine (BPDA-ODA) in n-methyl 2-pyrollidone (NMP) solvent was used for film fabrication. The cast films are in the range of 50-100 microns. The carbon black has an average particle size of 30-70 nm and an aggregate size of 100-200 nm. The loading of carbon is kept below 10% v/v that results in electrical conductivity in the range 10⁻⁶ to 10⁻² S cm⁻¹ and is in the semiconducting region as shown in FIG. 2.

FIG. 3 shows the electrical resistance vs. temperature graph for a nanocomposite film with carbon content 5% v/v cast on Silicon substrate. The electrical resistance decreased with increase in temperature, which is a typical semiconducting characteristic. The graph also shows the reduced hysteretic behaviour of the electrical resistance when subjected to thermal cycling.

FIG. 4 shows the temperature dependent electrical resistance variation in freestanding and supported carbon-polyimide nanocomposite thin film. The difference in the electrical resistivity changes in the two types of films shows the effect of substrate on the electrical behaviour in the polymer nanocomposite films. An advantage of this invention is that compared to polymer films with particle loadings in the percolative range there is very low hysteresis as shown in FIG. 3. Because of the relative low loadings, the micromechanical properties of the composite are similar to those of the pure polyimide as shown in FIG. 5. The resistance against the static strain obtained on the sensors of this invention are shown in FIGS. 6 and 7. Under tensile mode, the free-standing strain sensor film shows a gauge factor of 8 (FIG. 6) and under bending mode, the strain sensor film fixed onto a Silicon substrate, exhibits a gauge factor of 12. Gauge factors upto a value of 25 has been obtained when strain sensor elements are used on different substrates.

With some substrates a gauge factor of 25 is possible. Conventional metal strain gauges usually have gauge factors of <5.

Applications of these unique capabilities this SSE material are exemplified by its application to monitor the micromechanical behaviour of a carbon fibre composite rowing Oar.

The following are examples obtained by placing these strain sensor elements on the rowing oars that demonstrate their potential applications.

FIG. 8 shows a schematic representation of the left hand Oar (LO). Distance from the blade is measure from the point were the shaft joins the blade. The position is determined with reference to the blade. Table I provides the exact geometrical location of the SSEs on the Oar under test.

TABLE 1
Position details of the SSEs on the Oar as well as their respective
electrical resistance values at ambient temperature.

| | | | | |
|---|---|---|---|---|
| | Distance | | Angle formed with | |
| Strain | from the | Position on the | respect to the | Resistance |
| Gauge | blade (mm) | Oar | shaft axis | (k□) |

Right hand Oar (RO)

| | | | | |
|---|---|---|---|---|
| SG1 | 300 | Front | 0° | 87.7 |
| SG2 | 500 | Front | 45° | 93.6 |
| SG3 | 600 | Front | 0° | 83.3 |
| SG4 | 900 | Front | 0° | 84.2 |
| SG5 | 800 | Bottom | 0° | 80.7 |

Experimental Arrangement:

The SSEs used in this demonstration consisted of strips of 5 mm length, 1 mm width and around 0.06 mm thick. The electrical resistance of the SSEs were measured using a computer controlled data acquisition system provided with a multimeter while rowing movement was simulated using a Universal Testing Machine (INSTRON) by clamping the Oar horizontally with the front of the blade facing down, holding the Oar from the handle to the button and pulling the end of the shaft upwards using the INSTRON. The rowing Oar was held from the handle up to the sleeve to a concrete table to assure no movement or deformation of this section of the Oar occur during the experiment. The end of the shaft, where it joins with the blade, is attached to the INSTRON using a special designed fixture. The vertical displacement of the blade produced at this point was around 130 mm for a force of 300 N. The Oar was subjected to cyclic deformation at a speed of 1000 mm per minute (about 112 loading cycles over 1450 seconds in a continuous experiment). The electrical resistance of all the SSEs were monitored simultaneously.

FIG. 9 shows the resistance variation with time during the last ten cycles: The SSEs placed at different locations experienced different amount of strains which was reflected in variations in their respective resistance ratios. Strain gauges SG3 (positioned at 600 mm and SG4 positioned at 900 mm from the center of the blade produced similar strain response due to the applied load indicating that the deformation characteristics of the Oar at these two positions is similar. These two SSEs also showed the maximum response indicating that the Oar shaft deformation is maximum at these locations. The strain gauge SG1 (positioned at 300 mm) exhibited lower strain comparing to SG3 and SG4 (two thirds) indicative of smaller deformation of the Oar shaft at this location and SG2 (positioned at 500 mm) showed minimum strain. The strain gauge SG5 placed at 800 mm along the axis (top position) exhibited compression characteristics when the Oar was subjected to tensile load of 300 newtons.

The above experiment demonstrates the capability of these SSEs in monitoring the deformation of the rowing Oar quantitatively which has enabled us to identify maximum and minimum strain position on the Oar. This experiment has also demonstrated the capability of our strain sensor element to respond to compressional deformation as shown by the behaviour of the strain sensor element SG5 which was placed along the axis of the Oar shaft but at 90° with respect to the position of the other strain sensing element.

FIG. 10 shows the plot of resistance variation with applied load. The electrical resistance changed is from 83,300 ohms for load free condition to 83,700 ohms for 300 newtons. Linear variation of resistance with applied load was achieved. The behaviour was the same for all the strain sensor elements placed along the axis. The electrical resistance response was highly reproducible in all the strain sensor elements under cyclic loading when the temperature of the strain sensors were maintained constant.

Because of their semiconducting nature, electrical resistance under load free condition changed with temperature. However, the rate of change of resistance of the strain sensor element with temperature remained the same. For instance the FIG. 11 shows the resistance variation with applied load for the strain sensor element SG1 at two different temperatures. The effect of environmental temperature is to shift the resistance vs applied load curve along the Y-axis. However, load coefficient of resistance (slope) remains the same. Demonstration of the sensing of compressive deformation characteristics of the our strain sensor element.

In FIG. 8, the strain sensor element SG5 that was positioned along the shaft but at 90° to the other SSEs showed decrease in resistance with increase in applied load. This is due to the sideway compressive component of the SG5 along the shaft axis.

Using the INSTRON, the load was applied on the Oar shaft in the opposite direction so that all the strain sensor elements that were subjected to extensional deformation earlier were now compressed under this loading configuration.

FIG. 12 shows resistance variation plotted against time during cyclic loading on a given strain sensor element. The maximum load applied on the shaft during extensional deformation of the strain sensor element was maintained at 300 N, a maximum load of 200 N was maintained during the deformation experiments on the Oar shaft in the opposite direction.

FIG. 12 shows the continuous variation in the resistance of a strain sensor element under cyclic loading in the positive as well as negative directions. In both the directions, the deformation observed also was found to be proportional to the load.

This is more clearly seen in FIG. 13 when the above data is plotted as relative change in resistance against applied load for both extensional and compressive loading.

FIG. 14 shows the relative change of resistance of the various strain gauges that are placed on the Oar along the axis of the shaft which was subjected to extensional and compressive deformation arising from a load of 200 newtons. The minor variation seen in the values for each strain gauge may be due to small experimental variations in positioning the SSE films along the shaft axis.

Because of the unique capability of the strain sensing element to electrically respond to extensional and compressive deformations, by placing the SSE strips in specific geometrical positions on the shaft, they can be used to measure the torsional deformations occurring in the material under test.

In an experiment to demonstrate this behaviour of these carbon polymer nanocomposite thin films, the SSE in the form of thin strip was placed such that the its length is at 45° to the axis of the shaft. The shaft of the Oar was then subjected to torsional deformations in the clockwise and as well as anti-clockwise directions. Under this configuration, the SSE undergoes extensional stress when the torsional force was applied in one direction and compressive stress when the direction of the torsional force was reversed. Accordingly the electrical response from the SSE is positive change in resistance when torsional force is applied in one direction and negative change when the direction is reversed. The relative change also varied with the amount of torsional deformation.

As shown in FIG. 15 torque was applied this strain sensor element SG2 by twisting the Oar clockwise and as well as in anti clockwise directions. The SG2 experienced compressive stress in one direction while it experienced a tensile stress in the opposite direction. The change in the resistance values depended on the degree of torque and hence the degree of rotation experienced and the sign of the change depended on the direction of the applied torque.

The carbon fibre shaft used for torsional deformations measurements above is a hollow tube with decreasing diameter from the Oar handle to Oar blade and hence the determination of the torsional deformation quantitatively is a complex task. A separate experiment was carried out with an INSTRON machine to demonstrate the performance of the SSE in quantitative terms. The schematic of the experimental set up is as shown in the FIG. 16.

A hollow tube 11 made of carbon fibre composite of uniform bore was used. The set up consisted of the tube 11 clamped with anchors 14 to a fixed base 12 on one end and submitted to a torsional force at the other end which is supported in bearings 15. The dimensions of the tube are 1500 mm long, 44.7 mm inner diameter and 46.2 mm outer diameter. The SSE 17 in the form of a thin strip was placed such that its length was at 45° to the axis of the tube and 100 mm from the point where the tube was anchored. The tube 11 was then subjected to torsional deformations by applying a torque of 150 N m in the clockwise and 120 N m in the anti-clockwise direction using a moving arm 16 (lever) and an INSTRON machine. The torque was applied at a point 1160 mm from the anchored point and 1060 mm from the sensor location. In order to minimize the effect of bending of the oar due to the applied torque, the torque was applied at a point located between two fixed ball bearings separated 360 mm apart. Under this configuration, the SSE 17 experiences net effective extensional stress when the torsional force was applied in the clockwise direction and net effective compressive stress when the torsional force was applied in the anticlockwise direction. Accordingly the electrical resistance change of the SSE 17 is positive when the torsional force is applied in the clockwise direction and negative when is applied in the anticlockwise direction. The relative change also varied with the amount of torsional force applied.

The variation of a) torque applied on the tube, b) torsional deformation in angle (degrees) and c) electrical resistance of SSE with time when cyclic torsional deformation was applied is illustrated in FIG. 17.

The change in the resistance values depended on the degree of torque and hence the degree of rotation experienced and the sign of the change depended on the direction of the applied torque.

From the above it can be seen that this invention provides a strain gauge that can be used to measure large and micro strains. The polymer film can be easily cut and bonded to most surface types and shapes.

Those skilled in the art will realize that this invention can be implemented in embodiments other than those described without departing from the core teachings of this invention.

1. A composite polymeric strain sensor consisting of a non conducting polymer incorporating conductive nanoparticles below the percolating threshold and preferably less than 10% by volume of the polymer.

2. A strain sensor as claimed in claim 1 in which the polymer is a polyimide.

3. A strain sensor as claimed in claim 1 in which the conducting nanoparticle is carbon black having an average particle size of 30-70 nm and an aggregate size of 100-200 nm.

4. A strain sensor as claimed in claim 1 in which the electrical conductivity is within the range 10⁻⁶ to 10⁻² S cm⁻¹.

5. A strain sensor as claimed in claim 1 in which conducting tracks are deposited onto the composite polymeric strain sensor to enable the device to be connected to an external electric circuit.

6. A method of preparing a polymeric strain sensor which includes the steps of dispersing sufficient nanoparticulate conducting particles in a solution of a polymer and subsequently casting a film of the polymer to form a film in which the conductive nanoparticles are present in an amount below the percolating threshold of the polymer.

7. A method of preparing a polymeric strain sensor as claimed in claim 6 in which the polymer is a polyimide and the conducting nanoparticle is carbon black having an average particle size of 30-70 nm and an aggregate size of 100-200 nm.

8. A method of preparing a polymeric strain sensor as claimed in claim 6 in which the conductive nanoparticles are present in an amount less than 10% by volume of the polymer.

9. A method of preparing a polymeric strain sensor as claimed in claim 6 in which the conductive nanoparticles are present in an amount that provides the polymer composite with a conductivity within the range 10⁻⁶ to 10⁻² S cm⁻¹.

10. A strain sensor element formed from the polymer composite as claimed in claim 1 which is able to sense strain in extension, compression and torsion.
